(19) United States
(12) Patent Application Publication
(10) Pub. No.: US 2009/0228229 A1
(43) Pub. Date: Sep. 10, 2009

(54) System and method for calibrating and driving piezoelectric transducers

(76) Inventor: Titi Trandafir, S. Plainfield, NJ (US)

Correspondence Address: CARTER, DELUCA, FARRELL & SCHMIDT, LLP, 445 BROAD HOLLOW ROAD, SUITE 420, MELVILLE, NY, 11747, US

(21) Appl. No.: 12/075,608

(22) Filed: Mar. 4, 2008

(51) Int. Cl. B06B 1/06

(52) U.S. Cl. 702/106

(57) ABSTRACT

A system for calibrating and driving a piezo-electric transducer includes a voltage supply, a processor, an electrical signal switch, a Class F third order harmonic peaking blocking circuit segment enabling a drain voltage output having a time differential slope prior to signal passage through the harmonic peaking blocking circuit segment at turn-on of the switch, and wherein third order harmonics are rejected by the harmonic peaking blocking circuit, a programmable frequency oscillator in electrical communication with the processor and that drives the switch, wherein the processor programs the frequency oscillator to establish the operating frequency of the switch, and an inductor in parallel with a piezo-electric kinetic energy transducer that electrically represents a parallel resonant resistive-capacitive circuit segment that is configured to receive the oscillating signal input at the operating frequency and to produce kinetic energy output. A corresponding method of driving the transducer with the system is also disclosed.

### BACKGROUND

1. Technical Field

The present disclosure relates generally to systems and methods of calibrating and driving piezoelectric transducers.

2. Description of the Prior Art

Piezoelectric-ultrasonic transducers have many applications including as a therapeutic treatment device for bone injuries, bone growth and healing of various conditions such as osteopenia and osteoporosis. A piezoelectric transducer is characterized by an electric equivalent circuit and also an acoustic equivalent circuit. Such ultrasonic delivery/treatment devices are tuned or calibrated to operate with a particular, unique piezo-electric ceramic transducer. A manufacturer must manually calibrate each treatment delivery device to a particular transducer and a unique transducer driving circuit must be shipped with the transducer as a matched pair. If a device fails in the field, the entire device with driving circuit and transducer must be replaced with a new pair. The transducer is specified to very tight tolerances specifically as to frequency of operation, impedance, and band-width. The tight tolerances require a great deal of manual labor to calibrate the transducer, thereby adding significant costs both to the production and to the utilization of the transducer.

More recently, for safety considerations, Talish et al., in U.S. Pat. No. 7,108,663 issued Sep. 19, 2006, incorporated herein by reference, disclose ultrasonic transducers configured with a timing means and interlock to automatically place an ultrasonic signal generator into a non-signal generating mode.

### SUMMARY

The present disclosure relates to a system and method for tuning or calibrating and also driving a piezo-electric transducer for producing kinetic energy and in particular a piezo-electric transducer as used in ultrasonic therapy.

In one embodiment, the present disclosure relates to a system for at least one of calibrating and driving a piezo-electric transducer that includes a voltage supply, a processor, an electrical signal switch in electrical communication with the voltage supply, a Class F third order harmonic peaking blocking circuit segment in electrical communication with the voltage supply and with the electrical signal switch and configured to enable a drain voltage output having a time differential slope prior to signal passage through the harmonic peaking blocking circuit segment at turn-on of the switch, and wherein third order harmonics are rejected by the harmonic peaking blocking circuit;, a programmable frequency oscillator in electrical communication with the processor and that drives the switch, wherein the processor programs the frequency oscillator to establish the operating frequency of the switch, and an inductor in electrical communication with the harmonic frequency blocking circuit segment wherein the inductor is disposed to enable electrical connection in parallel with a piezo-electric kinetic energy transducer. The transducer electrically represents a parallel resonant resistive-capacitive circuit segment that is configured to receive the oscillating signal input at the operating frequency and to produce kinetic energy output. The system may further include a piezoelectric transducer electrically connected with the inductor, wherein magnitude of the time differential slope and magnitude of the drain voltage prior to switch turn on are indicative of transducer electrical operating efficiency, and wherein the processor measures, at at least a first operating frequency established via the programmable frequency oscillator, at least one of the drain voltage output and time slope differential prior to switch turn-on.

The system may also be configured wherein the processor measures, at at least a second operating frequency established via the programmable frequency oscillator, at least one of the drain voltage output and time slope differential prior to switch turn-on, wherein the processor compares the at least one of the drain voltage output and time slope differential prior to switch turn-on measured at the first operating frequency to the at least one of the drain voltage output and time slope differential prior to switch turn-on measured at the second operating frequency, and wherein the processor selects one of the first operating frequency and the second operating frequency as exhibiting at least one of drain voltage output and time slope differential indicative of a higher transducer electrical operating efficiency. Additionally, the system may include a memory resource enabling storage of at least one of the at least one of the drain voltage output and time slope differential prior to switch turn-on measured at the first operating frequency and the at least one of the drain voltage output and time slope differential prior to switch turn-on measured at the second operating frequency. The system may be configured wherein the processor stores in the memory resource at least one of the at least one of the drain voltage output and time slope differential prior to switch turn-on measured at the first operating frequency and the at least one of the drain voltage output and time slope differential prior to switch turn-on measured at the second operating frequency. Additionally, the system may be configured wherein one of the at least one of the drain voltage output and time slope differential prior to switch turn-on measured at the first operating frequency and the at least one of the drain voltage output and time slope differential prior to switch turn-on measured at the second operating frequency is indicative of higher transducer electrical operating efficiency.

In one embodiment, the system may be configured wherein the Class F third order harmonic peaking frequency blocking circuit segment precludes at least fifth order harmonics through the drain voltage.

In one embodiment, the system may include an ultrasonic power meter disposed in acoustic communication with the piezoelectric transducer and in electrical communication with the processor. The ultrasonic power meter may measure acoustic power of the transducer at at least the first operating frequency. The system may be configured wherein the processor associates the acoustic power of the transducer at at least the first operating frequency with the at least one of the drain voltage output and time slope differential prior to switch turn-on at at least the first operating frequency. The system may further include a memory resource enabling storage of at least one of the drain voltage output and time slope differential prior to switch turn-on measured at the first operating frequency and the acoustic power of the transducer associated with the at least first operating frequency. The system may be configured wherein the processor stores in the memory resource at least one of the at least one of the drain voltage output and time slope differential prior to switch turn-on measured at the first operating frequency and the acoustic power of the transducer associated with the at least first operating frequency. The system may also be configured wherein the ultrasonic power meter measures acoustic power of the transducer at at least the first operating frequency and the second operating frequency and wherein the processor associates the acoustic power of the transducer at at least the first operating frequency with the at least one of the drain voltage output and time slope differential prior to switch turn-on at at least the first operating frequency, and wherein the processor associates the acoustic power of the transducer at at least the second operating frequency with the at least one of the drain voltage output and time slope differential prior to switch turn-on at at least the second operating frequency.

Additionally, the system may be configured wherein the processor selects one of the first operating frequency and the second operating frequency as exhibiting at least one of drain voltage output and time slope differential indicative of a higher transducer electrical operating efficiency with respect to the acoustic power measured by the radiometer at the selected frequency. The system may further include a memory resource, the memory resource enabling storage of at least one of the drain voltage output and time slope differential prior to switch turn-on measured at the selected operating frequency; the associated acoustic power of the transducer at at least the selected operating frequency; and the selected operating frequency. The system may be configured wherein the processor stores in the memory resource at least one of the drain voltage output and time slope differential prior to switch turn-on measured at the selected operating frequency; the associated acoustic power of the transducer at at least the selected operating frequency; and the selected operating frequency.

In one embodiment, the system may further include a piezoelectric transducer electrically connected with the inductor, and a memory resource having stored therein at least one of the drain voltage output and time slope differential prior to switch turn-on measured at a selected operating frequency, an associated acoustic power of the transducer at at least the selected operating frequency, and the selected operating frequency. The system may also be configured wherein the drain voltage output and time slope differential prior to switch turn-on measured at the selected operating frequency and the associated acoustic power of the transducer at at least the selected operating frequency are selected at an operating frequency of the transducer at which the transducer operates at a higher electrical efficiency with respect to the associated acoustic power as compared to operating frequencies of the transducer other than the selected operating frequency. The system may be configured wherein the processor retrieves from the memory resource at least one of the drain voltage output and time slope differential prior to switch turn-on measured at a selected operating frequency; the associated acoustic power of the transducer at at least the selected operating frequency; and the selected operating frequency. The system may be configured wherein the processor programs the frequency oscillator to establish the selected operating frequency as the operating frequency of the electrical signal oscillator switch therein to drive the piezoelectric transducer at the selected operating frequency retrieved from the memory resource.

The present disclosure relates also to a method for at least one of calibrating and for at least one of calibrating and driving the piezo-electric transduce. The system includes providing a voltage supply providing power to the system. The method also includes providing a Class F third order harmonic peaking blocking circuit segment in electrical communication with the switch and with the voltage supply and configured to enable a drain voltage output having a time differential slope prior to signal passage through the harmonic frequency blocking circuit at turn-on of the switch, and wherein third order harmonics are rejected by the harmonic frequency blocking circuit segment wherein the inductor is disposed to enable electrical connection in parallel with the piezo-electric kinetic energy transducer and wherein the transducer electrically represents a parallel resonant resistive-capacitive circuit segment that is configured to receive the oscillating signal input at the operating frequency and to produce kinetic energy output. The method may include providing the piezoelectric transducer electrically connected with the inductor wherein magnitude of the time differential slope and magnitude of the drain voltage prior to turn on of the switch are indicative of electrical operating efficiency of the transducer, and measuring, at at least a first operating frequency, at least one of the drain voltage output and time slope differential prior to switch turn-on.

The method may include measuring, at at least second operating frequency, at least one of the drain voltage output and time slope differential prior to switch turn-on, comparing at least the drain voltage output and/or time slope differential prior to switch turn-on measured at the first operating frequency to the drain voltage output and/or time slope differential prior to switch turn-on measured at the second operating frequency, and selecting the first operating frequency or the second operating frequency as exhibiting at least one of drain voltage output and time slope differential indicative of a higher electrical operating efficiency of the transducer.

The method may also further include the step of providing a memory resource that enables storage of the drain voltage output and/or time slope differential prior to switch turn-on measured at the first operating frequency and/or the drain voltage output and/or time slope differential prior to switch turn-on measured at the second operating frequency.

The method may further include the step of storing in the memory resource the drain voltage output and/or time slope differential and/or the drain voltage output and/or time slope differential. Additionally, the method may include the drain voltage output and/or time slope differential and/or the drain voltage output and/or time slope differential being indicative of higher electrical operating efficiency of the transducer.

The Class F third order harmonic peaking blocking circuit segment may preclude third order harmonics through the drain voltage. The method may include the step of measuring the acoustic power of the transducer at at least the first operating frequency. The method may also include the step of associating the acoustic power of the transducer at at least the first operating frequency with the at least the drain voltage output and time slope differential prior to switch turn-on at at least the first operating frequency.

The method may further include the step of providing the memory resource enabling storage of at least the drain voltage output and time slope differential prior to switch turn-on measured at the first operating frequency and the acoustic power of the transducer associated with the at least first operating frequency. The method may further include the step of storing in the memory resource at least one of the drain voltage output and/or time slope differential prior to switch turn-on measured at the first operating frequency and the acoustic power of the transducer associated with the at least first operating frequency.

Additionally, the method may further include the step of measuring acoustic power of the transducer at at least the first operating frequency and the second operating frequency. The method may also include the steps of associating the acoustic power of the transducer at at least the first operating frequency with the drain voltage output and/or time slope differential prior to switch turn-on at at least the first operating frequency, and associating the acoustic power of the transducer at at least the second operating frequency with the drain voltage output and time slope differential prior to switch turn-on at at least the second operating frequency. Additionally, the method may further include the step of selecting the first operating frequency or the second operating frequency as exhibiting at least one of drain voltage output and time slope differential indicative of a higher transducer electrical operating efficiency with respect to the acoustic power measured at the selected frequency.

Furthermore, the method may further include the steps of providing the memory resource and storing in the memory resource at least the drain voltage output and/or time slope differential prior to switch turn-on measured at the selected operating frequency; and/or the associated acoustic power of the transducer at at least the selected operating frequency; and/or the selected operating frequency.

The method may also include a method of driving a transducer. Specifically, the method may include the steps of providing piezoelectric transducer electrically connected with the inductor and providing memory resource having stored therein at least the drain voltage output and/or time slope differential prior to turn-on of switch measured at a selected operating frequency, and/or an associated acoustic power of the transducer at at least the selected operating frequency and/or the selected operating frequency.

The method of driving the transducer may further include the step of selecting the drain voltage output and time slope differential prior to switch turn-on and the associated acoustic power of the transducer at at least an operating frequency of the transducer at which the transducer operates at a higher electrical efficiency with respect to the associated acoustic power as compared to operating frequencies of the transducer at other than the selected operating frequency.

Additionally, the method of driving the transducer may include the step of retrieving from the memory resource at least one of the drain voltage output and/or time slope differential prior to switch turn-on measured at a selected operating frequency; and/or the associated acoustic power of the transducer at at least the selected operating frequency, and the selected operating frequency. Furthermore, the method may include the step of programming the frequency oscillator to establish the selected operating frequency as the operating frequency of the switch, and driving the piezoelectric transducer at the selected operating frequency retrieved from the memory resource.

### BRIEF DESCRIPTION OF THE DRAWINGS

The foregoing features of the present disclosure will become more readily apparent and will be better understood by referring to the following detailed description of exemplary embodiments, which are described hereinbelow with reference to the drawing wherein:

FIG. 1 illustrates schematically an ultrasound treatment delivery device that includes a transducer driving circuit and that is coupled to a piezoelectric transducer as a matched pair according to the prior art.

FIG. 2 illustrates a schematic circuit block diagram of a calibration and driving circuit according to one embodiment of the present disclosure for calibrating and driving a piezo-electric transducer;

FIG. 3 illustrates a partially schematic circuit diagram of a calibration and driving circuit according to one embodiment of the present disclosure for calibrating and driving a piezo-electric transducer;

FIG. 4 is a table of exemplary values for a resistive-capacitive parallel equivalent circuit, both wet and dry, at various frequencies representing a piezoelectric transducer according to one embodiment of the present disclosure that are used to create the specific numerical parameters of the electrical components of the calibration or tuning circuit of FIG. 3;

FIG. 5 is a graphical illustration of the output from a computer simulation of the method of tuning a piezoelectric transducer according to one embodiment of the present disclosure;

FIG. 6 is a table of numerical values for the magnitude of the electrical components in the circuit diagram of FIG. 3;

FIG. 7 is a block diagram of the calibration process according to one embodiment of the present disclosure for calibrating a piezoelectric transducer;

FIG. 8 is a graphical illustration of implementation of the method of calibrating a piezoelectric transducer according to one embodiment of the present disclosure; and

FIG. 9 is a block diagram of the driving process according to one embodiment of the present disclosure for driving a piezoelectric transducer.

### DETAILED DESCRIPTION

To advance the state of the art with respect to systems and methods of operating and using piezo-electric transducers, and particularly piezo-electric transducers used for ultrasonic therapy, such as transducers made from technical ceramics such as combinations of lead, zirconium and/or titanium, the present disclosure describes a system for calibrating and driving a piezo-electric transducer.

The present disclosure relates to a system for calibrating and/or driving a transducer which can be calibrated and driven or operated over a broader range of frequencies, the system enabling a “generic” transducer. Such a generic transducer facilitates and simplifies fabrication of the transducer and reduces manufacturing costs. The transducer may include a separate a cable and connector assembly which can be removably attached to the transducer. In one embodiment, a memory resource such as a memory chip is integrated with the transducer calibration and driving circuit or with the cable and connector assembly or supplied separately in a package. During calibration of the transducer, the acoustic power output of the transducer is measured by a radiometer which is connected to a processor such as a computer. The transducer is driven during the calibration process by substantially the same circuit that is used to drive or operate the transducer during end use application of ultrasonic therapy. Once the calibration process has been completed, the processor programs the memory resource with the appropriate parameters determined as providing optimum performance of the transducer, e.g., maximum electrical efficiency and acoustic power or efficiency, during the calibration process. The calibration process is performed for all transducers in a batch of transducers and can be automated.

Thus a complete batch or lot of transducers can be shipped from a facility without an associated driving circuit to which the transducer has been matched as a matched pair with close tolerances on the operating parameters. Instead, the appropriate parameters determined as providing optimum performance of the transducer during the calibration process are programmed into the memory resource that may be incorporated into the cable and connector assembly. The memory resource can be a memory chip integrated with the connector device or the memory resource may be a flash memory drive (sometimes referred to as a thumb drive or memory stick), a radiofrequency identification (RFID) tag or label, an electronic article surveillance (EAS) tag or label, a swipe card or other suitable memory resource.

Thus, ultrasound delivery/treatment devices, which include the substantially common transducer calibration and driving circuit, and the transducers can be shipped entirely separately from each other and not as a matched pair. Transducers can then be shipped separately. At the point of use, a doctor or other medical professional or an end user can then connect a separate transducer, having its optimum performance parameters stored on the memory resource, to a separate substantially common transducer calibration and driving circuit included within the ultrasound delivery/treatment device. The processor in the delivery/treatment device then receives information from the memory resource associated with the particular transducer and automatically calibrates itself to deliver the proper operating signal such as impedance, wet and dry, and frequency, to the driving circuit to assure optimum performance of the transducer during use, resulting in reduced power requirements for the power supply and longer battery life. Such a generic, non-precalibrated transducer that can be shipped separately from the delivery/treatment device, can be manufactured at a reduced cost as compared to a matched pair of delivery/treatment device and transducer according to the prior art.

Specifically, with respect to the design of the calibration and driving circuit, a third order peaking Class F peaking amplifier circuit is modified by inclusion of a piezo-electric transducer as a load. That is, the output network of a generic Class F third harmonic peaking power amplifier is assumed to be an ideal LC (inductance L, capacitance C) or transmission-line filter (linear, passive and lossless) that allows only fundamental and fifth order and higher harmonic frequencies power to pass through the load. The active device, e.g., a MOSFET is assumed to be an ideal current source or an ideal switch.

Referring first to FIG. 1, there is illustrated a matched pair of a piezoelectric transducer with a treatment delivery device with transducer driving circuit according to the prior art. More particularly, a treatment delivery device 1 that includes a transducer driving circuit incorporated therein interfaces at an interface 5 with a piezoelectric transducer 2. Therefore, the treatment delivery device 1 that includes the transducer driving circuit and the piezoelectric transducer 2 that interfaces with the treatment delivery device 1 at interface 5 forms a matched pair 10.

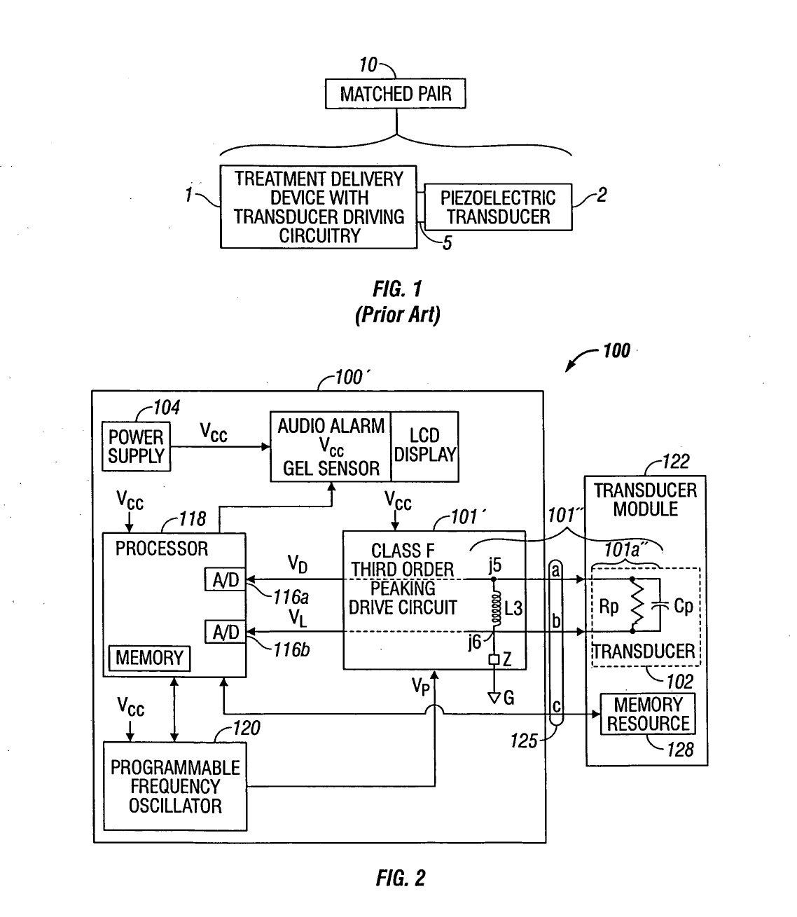

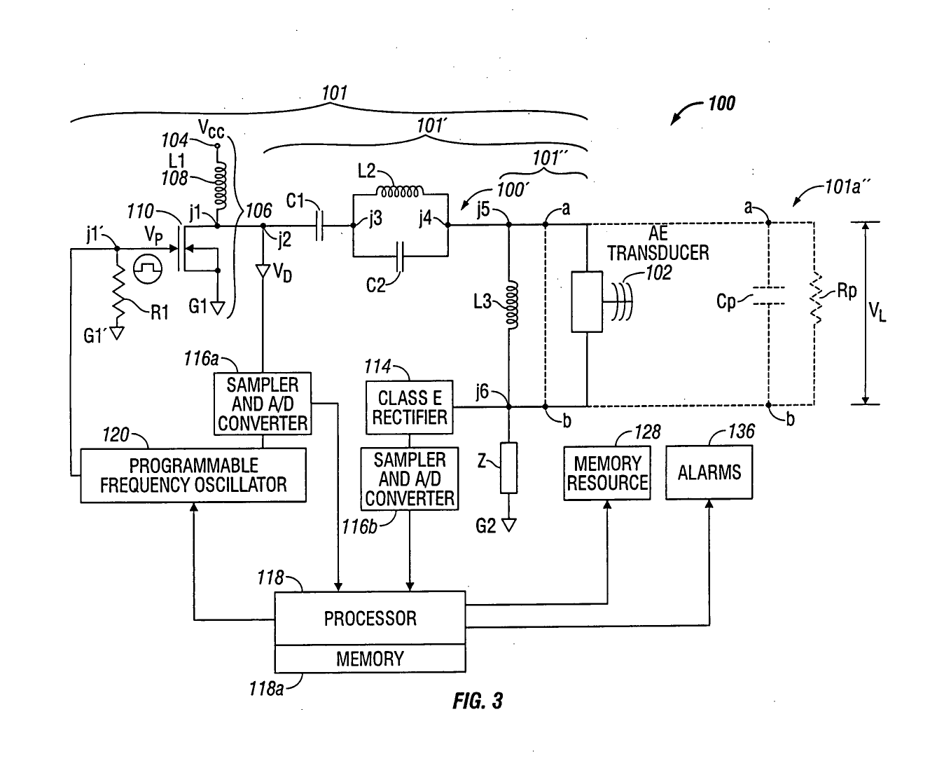

Referring now to the embodiments of the present disclosure as illustrated in FIGS. 2 and 3, FIG. 2 illustrates a schematic block diagram of one embodiment of a calibration and driving circuit system for a piezoelectric transducer according to the present disclosure. FIG. 3 illustrates a partially schematic circuit diagram of the calibration and driving circuit according to one embodiment of the present disclosure for calibrating and driving a piezo-electric transducer.

More particularly, FIG. 1 illustrates one embodiment of a system 100 for at least calibrating and driving a piezo-electric transducer 102 according to the present disclosure. The system 100 includes a calibration and driving electrical circuit 100′ that includes a voltage supply 104, e.g., a battery or a power supply providing a voltage potential V_{CC}, to a modified Class F third-harmonic peaking power amplifier 101. The voltage supply 104 is coupled to the electrical circuit 100′ through an inductor L1 that is in turn coupled to the circuit 100′ at first junction j1. The modified Class F third harmonic power amplifier 101 is in electrical communication with a transistor or oscillator switch 110, e.g. a mixed oxide semi-conductor field effect transistor (MOSFET), and that is also coupled to the circuit 100′ at junction j1. Thus, the receiver/oscillator switch 110, in turn, also is in electrical communication with the voltage supply 104. A processor 118 controls the overall operation of the system 100. The processor 118 includes memory 118a that may be internal to the processor, as shown, or the processor 118 is in electrical communication with an external memory (not shown).

A programmable frequency oscillator 120 is in electrical communication with the processor 118 and drives the switch 110. The processor 118 programs the frequency oscillator 120 to establish the operating frequency of the electrical signal oscillator switch 110, and therefore, the operating frequency of the modified Class F third-harmonic peaking power amplifier 101. The output of the frequency oscillator 120 is a square wave voltage Vp that operates the switch 110.

A resistor R1 is coupled to the circuit 100′ at junction j1′ between the frequency oscillator 120 and the switch 110. The resistor R1 is grounded at G1′ and prevents the MOSFET gate of the oscillator switch 110 from floating and thus shorting the voltage supply 104.

The modified Class F third-harmonic peaking power amplifier 101 includes a Class F third order harmonic peaking blocking circuit segment 101′ that is also in electrical communication with the voltage supply 104 and with the switch 110 and that is configured to enable a drain voltage output Vd at a second junction j2.

An inductor L3 is in electrical communication with the harmonic frequency blocking circuit segment 101′ wherein the inductor L3 is disposed to enable electrical connection in parallel with a piezo-electric transducer 102. The transducer 102 electrically represents a parallel resistive-capacitive circuit segment 101a″, represented by a resistor Rp and a capacitor Cp that is configured to receive the oscillating signal input from the switch 110 at the operating frequency and to produce kinetic energy output, e.g., ultrasonic energy. The transducer 102 may be made from a material such as ceramic or other suitable material that can be characterized as an equivalent Rp and Cp circuit, Particular suitable materials include technical ceramics such as combinations of lead, zirconium and/or titanium.

The harmonic frequency blocking circuit segment 101′ includes a capacitor C1 in series between second junction j1 and a third junction j3. A second capacitor C2 is connected in parallel with a second inductor L2 from the third junction j3 to a fourth junction j4. Thus, capacitor C1 is electrically coupled in series at junction j3, with inductor L2 and a capacitor C2 that are coupled between junctions j3 and j4 in parallel. The power amplifier segment 101′ is coupled at a fifth junction j5, in series with fourth junction j4, to a transducer tuning segment 101″ wherein the piezoelectric transducer 102 and an inductor L3 are coupled in parallel between fifth junctions j5 and a sixth junction j6. The inductor L3 is connected to ground G2 through an impedance Z that is coupled to the circuit 100′ at junction j6. The transducer tuning segment 101″ is coupled at junction j6 to an impedance Z draining to ground G2. Impedance Z may be a low value inductor, e.g., an inductor having an impedance value of about 400 nH, as described below with respect to FIG. 6. (Those skilled in the art will recognize that, and understand how, although the ground connections at G1, G1′ and G2 are illustrated as separate connections, the connections can be to a common ground).

Third order harmonics are rejected by the parallel circuit between junctions j3 and j4 formed by C2 and L2 of the harmonic frequency blocking segment 101′ and are monitored and measured by the processor 118 via a data sampler and analog-to-digital A/D converter 116a that is in electrical communication with, or an internal function of, the processor 118. The drain voltage output Vd is thus directed to the processor 118 through the data sampler and analog-to-digital A/D converter 116a.

In one embodiment, the circuit 100′ is completed by coupling a Class E rectifier 114 and a data sampler and analog-to-digital A/D converter 116b in between the junction j6 and the processor 118. The output of the rectifier 114 represents a voltage proportional to load voltage VL.

As described below, piezoelectric transducer 102 is represented by an equivalent circuit to resistive-capacitive segment 101″a. To establish the design of the circuit 100′, and specifically the numerical values of the various circuit parameters such as C1, L1, C2, L2, L3, R1, Z and Vcc, illustrated in FIG. 6, the piezoelectric transducer 102 is mathematically modeled between junction points a and b (that are electrically identical to junctions j5 and j6, respectively) as equivalent to the parallel RC circuit segment 101a″ represented by resistor Rp and capacitor Cp.

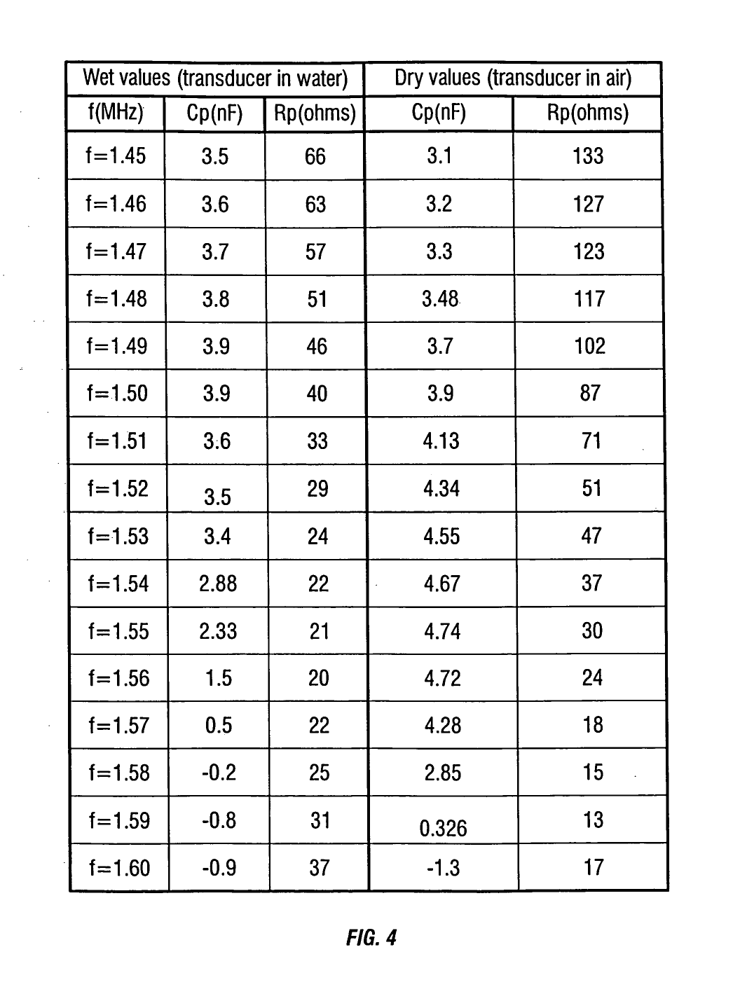

Referring to FIG. 4, typical wet values of an exemplary nominal 1.50 MHz transducer for capacitance of capacitor Cp in nanofarads (nF) and for resistance of resistor Rp are shown over a range of frequencies f1 . . . fn, beginning at at least a first frequency f1 equal to 1.45 MHz and including a second frequency f2 equal to 1.46 MHz, and extending to fn equal to 1.60 MHz. The range of frequencies f1 . . . fn may be chosen as ± a percentage deviation from a nominal transducer operating frequency f, e.g. if the nominal transducer operating frequency f is 1.50 MHz, and the percentage deviation is 10%, the range of frequencies f1 . . . fn would span about 1.35 MHz to about 1.65 MHz. Corresponding dry values of capacitance of capacitor Cp in nanofarads (nF) and resistance of resistor Rp at at least the first frequency f1 equal to 1.45 MHz and the second frequency j2 equal to 1.46 MHz. The wet values of Cp and Rp are the values exhibited by the transducer when placed in water. The dry values of Cp and Rp are the values exhibited by the transducer when placed in air. Using a circuit simulation program such as PSPICE (e.g., Cadence PCB design software by EMA Design Automation, Inc., Rochester, N.Y., USA), the system 100 is simulated wherein the circuit 100′ is assumed to be coupled to a “phantom” transducer that is represented by the parallel resonant resistive-capacitive circuit segment 101a″, represented by the resistor Rp and capacitor Cp connected in parallel, as shown by dashed lines in FIG. 3.

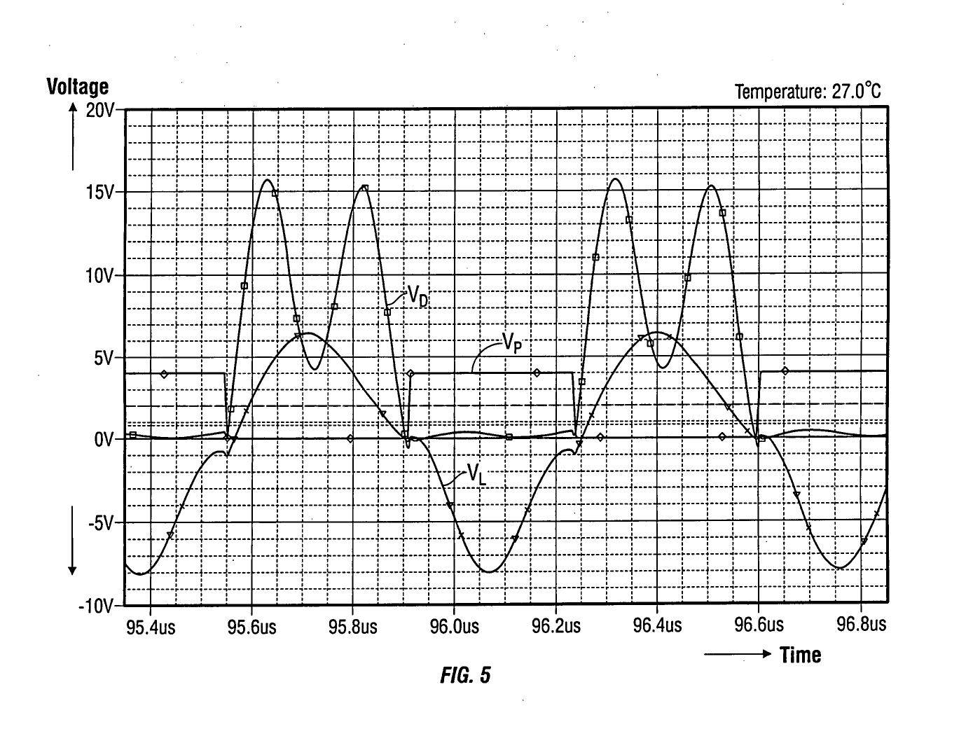

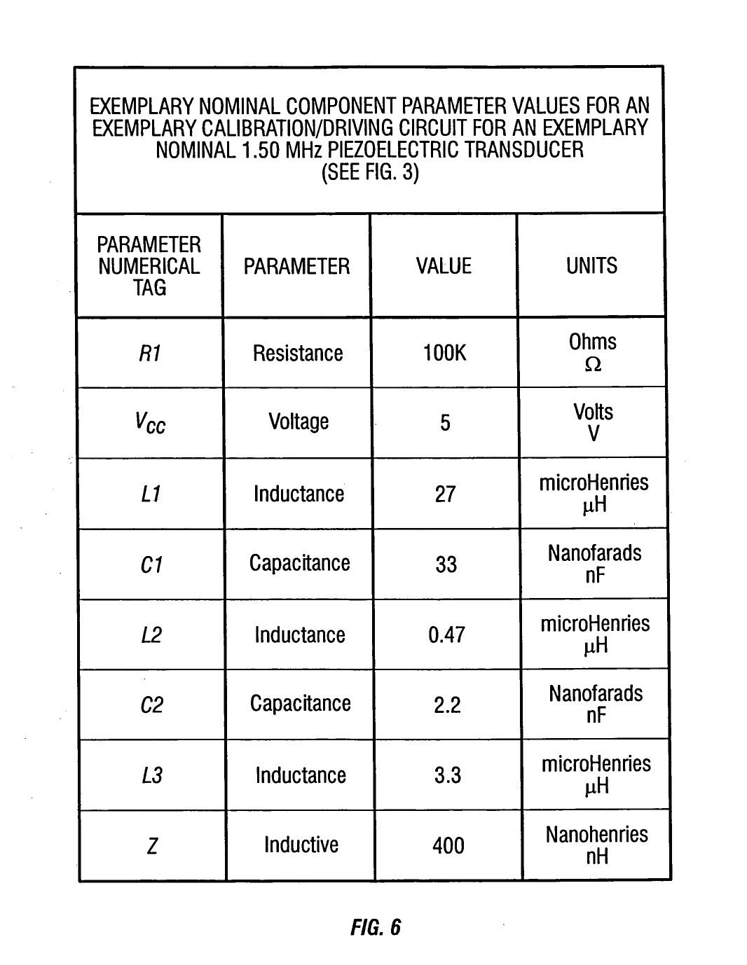

FIG. 5 illustrates a graphical output of a PSPICE simulation of the system 100 with third-harmonic Class F peaking power amplifier 101 depicted in FIG. 3 with circuit parameter values of Cp and Rp from FIG. 4 at f=1.45 Mhz. Represented graphically are the drain voltage Vd of the switch 110 (e.g., MOSFET), the load voltage VL (across L3) and the drive signal voltage Vp of the switch 110. The various circuit parameters such as C1, L1, C2, L2, L3, R1, Z and Vcc, illustrated in FIG. 6 are then determined based on the PSPICE simulation. For other operating frequencies, (e.g., 1 Mhz, 3 Mhz or 5 Mhz) the circuit parameter values such as C1, L1, C2, L2, L3, R1, Z and Vcc determined in FIG. 6 will be different and can be calculated by one skilled in the art.

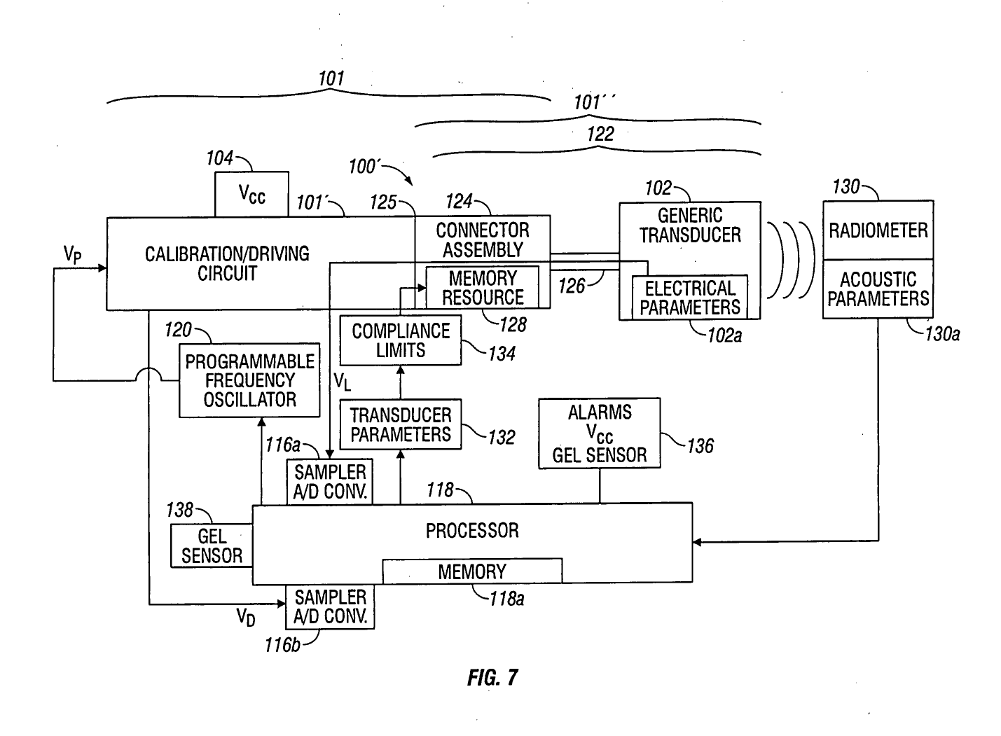

FIG. 7 illustrates a block diagram of the system 100 for at least calibrating and driving a piezoelectric transducer as illustrated previously in FIGS. 2 and 3. The system 100 is shown during the calibration process and is substantially similar to the system as shown in FIGS. 2 and 3 except that transducer module 122 is shown with generic transducer 102 coupled to the calibration and driving circuit 100′ with Class F amplifier 101. An ultrasonic power meter (radiometer) 130 is disposed in acoustic communication with the piezoelectric transducer 102 and in electrical communication with the processor 118. Transducer module 122 includes a connector assembly 124 and may be configured with a cable 126 that is in electrical communication with the transducer 102. A memory resource 128 is shown associated with the connector assembly 124.

The connector assembly 126 interfaces with the electrical circuit 100′ at interface 125. In FIG. 2, the interface includes the junction points a and b, discussed above, and a junction point c for the memory resource 128. The memory resource 128 may be a memory chip integrated with the connector assembly 124 and/or the cable 126 or with the transducer 102. Alternatively, the memory resource 128 may be an independent flash memory drive (sometimes referred to as a thumb drive or memory stick), a radiofrequency identification (RFID) tag or label, an electronic article surveillance (EAS) tag or label, a swipe card or other suitable memory resource.

The radiometer 130, such as an OHMIC Ultrasound Power Meter, Model UPM-DT-1, Ohmic Instruments, Easton Md., USA, or equivalent, is configured to measure acoustic power of the transducer 102 at at least a first operating frequency f1 established via the programmable frequency oscillator 120, and in one embodiment, over a range of frequencies, such as illustrated in FIG. 4. The acoustic power of the transducer at at least the first operating frequency f1 is read by the processor 118 as one of the acoustic parameters 130a provided to the processor 118 by the radiometer 130.

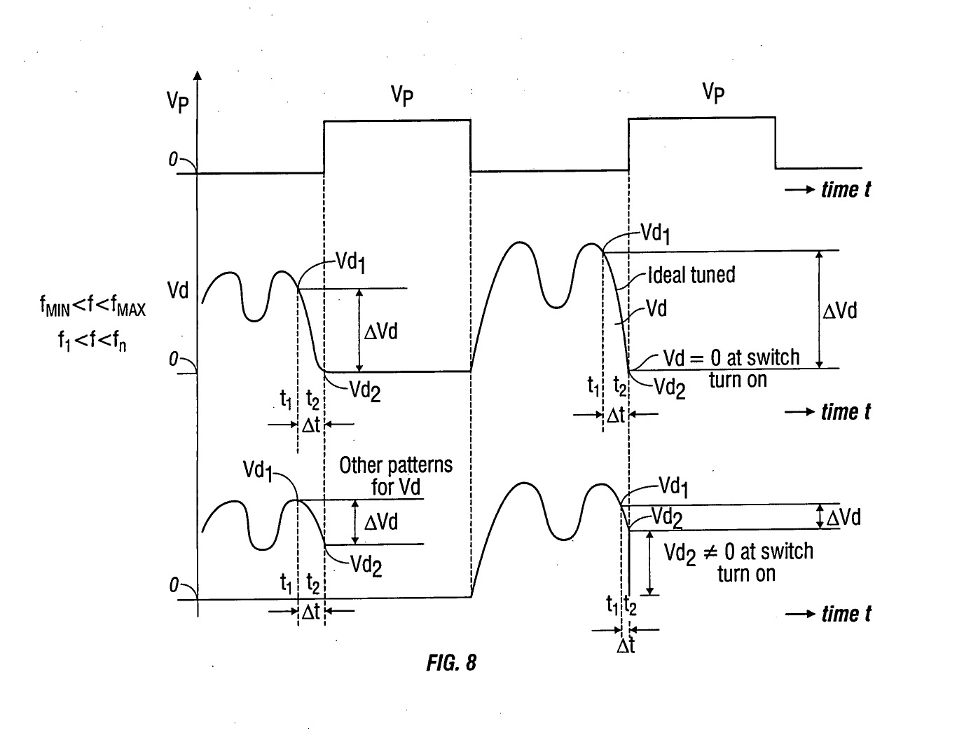

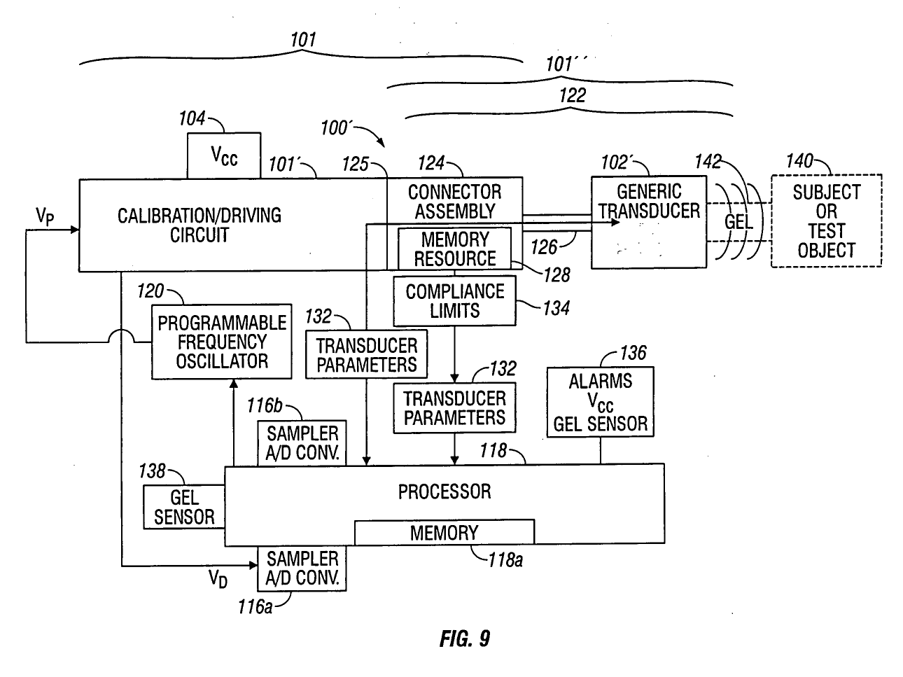

Referring also to FIGS. 7 and 8, in addition to FIG. 9, the general operation of the system 100 will be explained for the determination of the magnitude of the drain voltage time differential slope ΔVd/Δt and magnitude of the drain voltage Vd prior to turn on of the oscillator switch 110, which are indicative of electrical operating efficiency. The processor 118 measures, at at least a first operating frequency f1 established via the programmable frequency oscillator 120, at least the drain voltage output Vd and/or the drain voltage time differential slope ΔVd/Δt prior to turn-on of the switch 110. The drain voltage differential ΔVd and the time differential Δt are defined as the difference between drain voltage Vd1 at time t1 and drain voltage Vd2 at time t2 wherein time t2 is the time of turn on of switch 110 and time t1 is a time just prior to turn-on of switch 110. Thus, ΔVd=Vd1−Vd2 and Δt=t1−t2. So the slope of the drain voltage time differential can be represented by equation (1) as follows:

ΔVd/Δt=(Vd1−Vd2)/(t1−t2) (1)

For an exemplary case of sampling data readings for a nominal 1.5 MHz piezo-electric transducer, having a quarter cycle of 165 nanoseconds, the processor 118 instructs the sampler and A/D converter 116a to acquire four A/D data samples of Vd1 and Vd2 in a time period between the first time t1 and the second time t2 that is less than 165 nanoseconds.

The greater the slope represented by ΔVd/Δt, the greater the electrical efficiency of the transducer because the drain voltage Vd is minimized at the time t2 of turn-on of the switch 110. Those skilled in the art will recognize that although simply second drain voltage Vd2 and the second time t2 can be considered as representing electrical efficiency and data acquired solely for those parameters without consideration of the first drain voltage Vd1 and the first time t1, the slope ΔVd/Δt provides enhanced insight into performance of the transducer 102.

The processor 118 measures, at at least a second operating frequency f2 established via the programmable frequency oscillator 120, at least the drain voltage output Vd and time slope differential ΔVd/Δt prior to switch turn-on. The processor 118 compares at least the drain voltage output Vd and/or time slope differential ΔVd/Δt prior to switch turn-on measured at the first operating frequency f1 to at least the drain voltage output Vd and/or time slope differential ΔVd/Δt prior to switch turn-on measured at the second operating frequency f2. The processor 118 selects one of the operating frequencies f1 or f2 as exhibiting at least drain voltage output Vd and time slope differential ΔVd/Δt as being indicative of a higher transducer electrical operating efficiency or at least a decreased electrical power input.

The processor 118 also associates the acoustic power of the transducer 102 at at least the first operating frequency f1 with at least the drain voltage output Vd1 and time slope differential prior to switch turn-on at at least the first operating frequency f1.

The processor 118 then compares at least the drain voltage output Vd1 or time differential slope ΔVd/Δt prior to switch turn-on measured at the first operating frequency f1 to at least the drain voltage output Vd1 or time slope differential ΔVd/Δt prior to switch turn-on measured at the second operating frequency f1. In one embodiment, the processor 118 also sweeps over a range of frequencies f, such as f1 to fn (or fmin to fmax). The processor 118 then selects, as appropriate, either the first operating frequency f1 or the second operating frequency f2 to fn as exhibiting at least drain voltage output Vd and/or time differential slope ΔVd/Δt indicative of a higher transducer electrical operating efficiency at the associated acoustic power for that selected frequency. During the calibration process, the processor 118 stores the acquired data readings of frequencies f, drain voltage Vd and time differential slope ΔVd/Δt, and associated acoustic power in an internal or external memory 118a for retrieval during the selection process.

The acquired data readings of frequencies f, drain voltage Vd and time differential slope ΔVd/Δt become the electrical parameters 102a characteristic of the transducer 102. The processor 118 also associates the readings of acoustic parameters 130a, e.g., the acoustic power of the transducer 102, acquired from the radiometer 130, with the electrical parameters 102a to become the transducer parameters 132 characteristic of the transducer 102. The transducer parameters 132 may be associated with the serial number of the particular transducer that has been calibrated and the serial number together with the transducer parameters 132 may be stored in the memory resource 128.

The calibration process is performed both for the transducer 102 being subjected to wet conditions, e.g., in water, and dry conditions, e.g., in air. The transducer parameters 132 thus may be further differentiated by the readings under wet conditions, representative of proper treatment with gel in place between the transducer and the subject or patient, and the readings under dry conditions which are indicative of lack of gel in place between the transducer and the subject or patient. The transducer parameters 132 stored in the processor memory 118a and/or the memory resource 128 thus may include the readings under wet conditions and the readings under dry conditions. In one embodiment, the processor 118 selects the transducer parameters 132 that are indicative of higher transducer relative electrical operating efficiency. The memory resource 128 enables storage of at least the drain voltage output Vd and/or time slope differential ΔVd/Δt prior to switch turn-on measured at the selected operating frequency f; and/or the associated acoustic power of the transducer 102 at at least the selected operating frequency f, and the selected operating frequency f.

The processor 118 may also store in the memory resource 128 treatment compliance limits 134 for the particular transducer and ultrasonic therapy regimen. The processor 118 may set appropriate alarm limits based on actual usage of the transducer by the subject or test object, or by a medical professional, with respect to the compliance limits. The alarm limits may be set by the processor 118 to trigger one or more alarms 136 in electrical communication with the processor 118.

The system 100 may also include one or more gel sensors 138. In actuality, the gel sensors 138 are not hardware components. Rather, the presence of gel is detected by the processor 118 determining that the operating characteristics of the transducer 102 at a particular operating frequency f are representative of the dry values of Rp and Cp of transducer 102. Upon making such a determination, the processor 118 triggers the alarm 136 based on lack of proper gel in contact with the skin during treatment. In addition to compliance limits, the alarms may include low or high power supply voltage Vcc or current.

FIG. 9 illustrates the system 100 during the driving process according to one embodiment of the present disclosure for driving a generic piezoelectric pressure transducer 102. The system 100 may be the very same system 100 used to calibrate the transducer 102 by a supplier or the system 100 may be a different system 100 that is configured substantially as a standardized calibration and driving system for the transducer 102. Similarly, the transducer 102 may be a standardized generic transducer or the same transducer calibrated by the system 100 during a calibration process. The transducer 102 is placed in contact with a subject or a test object 140 through a gel coupling 142.

In particular, during the driving process, a piezoelectric transducer 102 is electrically connected to the calibration and driving circuit 100′ by connecting with the with the inductor L3 at junction points a and b (see FIGS. 2 and 3). Also provided is a memory resource 128 that has stored therein the transducer parameters 132 that may include at least the drain voltage output Vd and/or time slope differential ΔVd/Δt prior to switch turn-on measured at a selected operating frequency f and/or an associated acoustic power of the transducer 102 at at least the selected operating frequency f and/or the selected operating frequency f. The selected operating frequency f may be indicative of the transducer operating at a higher electrical efficiency with respect to the associated acoustic power as compared to operating frequencies of the transducer 102 other than the selected operating frequency f.

The processor 118 then retrieves from the memory resource 128 at least the drain voltage output Vd and/or the time slope differential ΔVd/Δt prior to switch turn-on measured at the selected operating frequency f and/or the associated acoustic power of the transducer 102 at at least the selected operating frequency f, and/or the selected operating frequency f.

The processor 118 then programs the frequency oscillator 120 to establish the selected operating frequency f as the operating frequency of the electrical signal oscillator switch 110 therein to drive the piezoelectric transducer 102 at the selected operating frequency retrieved from the memory resource 128.

The processor 118 monitors usage of the transducer by the subject or test object 140 against the compliance limits 134 and, when appropriate, triggers the alarm(s) 136.

Those skilled in the art will recognize that during the driving process of the transducer 102, the processor 118 may also measure the drain voltage output Vd and/or the time slope differential ΔVd/Δt prior to turn-on of the oscillator switch in the same manner as described above for the calibration process with respect to FIG. 7. In one embodiment, an ultrasonic power meter, such as radiometer 130, which may be portable, may disposed in acoustic communication with the piezoelectric transducer 102, as described above with respect to FIG. 7, to implement the calibration process.

Referring again to FIGS. 2-9, those skilled in the art will recognize that the present disclosure relates also to a method for at least one of calibrating and driving a piezo-electric transducer, e.g., piezoelectric transducer 102. The method includes the step of providing the system 100 for at least one of calibrating and driving the piezo-electric transducer 102. The system 100 includes providing voltage supply 104, e.g., Vcc providing power to the system 100. The method also includes providing the Class F third order harmonic peaking blocking circuit segment 101′ in electrical communication with the switch 110 and with the voltage supply 104 and configured to enable drain voltage output Vd having time differential slope ΔVd/Δt prior to signal passage through the harmonic frequency blocking circuit 101 at turn-on of the oscillator switch 110, and wherein third order harmonics are rejected through the drain voltage output Vd at junction j2 and inductor L3 in electrical communication with the harmonic frequency blocking circuit segment 101′ wherein the inductor L3 is disposed to enable electrical connection in parallel with the piezo-electric kinetic energy transducer 102 and wherein the transducer 102 electrically represents a parallel resonant resistive-capacitive circuit segment 101a″ that is configured to receive the oscillating signal input at the operating frequency f and to produce kinetic energy output. The method may include providing the piezoelectric transducer 102 electrically connected with the inductor L3 wherein magnitude of the time differential slope ΔVd/Δt and magnitude of the drain voltage Vd prior to turn on of the switch 110 are indicative of electrical operating efficiency of the transducer 102, and measuring, at at least a first operating frequency f1, at least one of the drain voltage output Vd and time slope differential ΔVd/Δt prior to switch turn-on.

The method may include measuring, at at least second operating frequency f2, at least one of the drain voltage output Vd and time slope differential ΔVd/Δt prior to switch turn-on, comparing at least the drain voltage output Vd and/or time slope differential ΔVd/Δt prior to switch turn-on measured at the first operating frequency f1 to the drain voltage output Vd and/or time slope differential ΔVd/Δt prior to switch turn-on measured at the second operating frequency f2, and selecting the first operating frequency f1 or the second operating frequency f2 as exhibiting at least one of drain voltage output Vd and time slope differential ΔVd/Δt indicative of a higher electrical operating efficiency of the transducer 102.

The method may also further include the step of providing memory resource 128 that enables storage of the drain voltage output Vd and/or time slope differential (ΔVd/Δt) prior to switch turn-on measured at the first operating frequency f1 and/or the drain voltage output Vd and/or time slope differential ΔVd/Δt prior to switch turn-on measured at the second operating frequency f2.

The method may further include the step of storing in the memory resource 128 the drain voltage output Vd and/or time slope differential ΔVd/Δt and/or the drain voltage output Vd and/or time slope differential ΔVd/Δt. Additionally, the method may include the drain voltage output Vd and/or time slope differential ΔVd/Δt and/or the drain voltage output Vd and/or time slope differential ΔVd/Δt being indicative of higher electrical operating efficiency of the transducer 102.

The Class F third order harmonic peaking blocking circuit segment precludes third order harmonics through the drain voltage Vd. The method may include the step of measuring the acoustic power of the transducer 102 at at least the first operating frequency f1. The method may also include the step of associating the acoustic power of the transducer 102 at at least the first operating frequency f1 with the at least the drain voltage output Vd and time slope differential ΔVd/Δt prior to switch turn-on at at least the first operating frequency f1.

The method may further include the step of providing the memory resource 128 enabling storage of at least the drain voltage output Vd and time slope differential ΔVd/Δt prior to switch turn-on measured at the first operating frequency f1 and the acoustic power of the transducer 102 associated with the at least first operating frequency f1. The method may further include the step of storing in the memory resource 128 at least one of the drain voltage output Vd and/or time slope differential ΔVd/Δt prior to switch turn-on measured at the first operating frequency f1 and the acoustic power of the transducer 102 associated with the at least first operating frequency f1.

Additionally, the method may further include the step of measuring acoustic power of the transducer 102 at at least the first operating frequency f1 and the second operating frequency f1. The method may also include the steps of associating the acoustic power of the transducer 102 at at least the first operating frequency f1 with the drain voltage output Vd and/or time slope differential ΔVd/Δt prior to switch turn-on at at least the first operating frequency f1, and associating the acoustic power of the transducer 102 at at least the second operating frequency f2 with the drain voltage output Vd and time slope differential ΔVd/Δt prior to switch turn-on at at least the second operating frequency f2. Additionally, the method may further include the step of selecting the first operating frequency f1 or the second operating frequency f2 as exhibiting at least one of drain voltage output Vd and time slope differential ΔVd/Δt indicative of a higher transducer electrical operating efficiency with respect to the acoustic power measured at the selected frequency f.

Furthermore, the method may further include the steps of providing the memory resource 128 and storing in the memory resource 128 at least the drain voltage output Vd and/or time slope differential ΔVd/Δt prior to switch turn-on measured at the selected operating frequency f; and/or the associated acoustic power of the transducer 102 at at least the selected operating frequency f; and/or the selected operating frequency f.

The method may also include a method of driving a transducer. Specifically, the method may include the steps of providing piezoelectric transducer 102 electrically connected with the inductor L3 and providing memory resource 128 having stored therein at least the drain voltage output Vd and/or time slope differential ΔVd/Δt prior to turn-on of switch 102 measured at a selected operating frequency f, and/or an associated acoustic power of the transducer 102 at at least the selected operating frequency f and/or the selected operating frequency f.

The method of driving the transducer may further include the step of selecting the drain voltage output Vd and time slope differential ΔVd/Δt prior to switch turn-on and the associated acoustic power of the transducer 102 at at least an operating frequency f of the transducer 102 at which the transducer 102 operates at a higher electrical efficiency with respect to the associated acoustic power as compared to operating frequencies of the transducer 102 at other than the selected operating frequency.

Additionally, the method of driving the transducer may include the step of retrieving from the memory resource 128 at least one of the drain voltage output Vd and/or time slope differential prior to switch turn-on ΔVd/Δt measured at a selected operating frequency f; and/or the associated acoustic power of the transducer 102 at at least the selected operating frequency f, and the selected operating frequency f. Furthermore, the method may include the step of programming the frequency oscillator 120 to establish the selected operating frequency f as the operating frequency of the switch 110, and driving the piezoelectric transducer 102 at the selected operating frequency f retrieved from the memory resource 102.

While several embodiments of the disclosure have been shown in the drawings and/or discussed herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A system for at least one of calibrating and driving a piezo-electric transducer comprising:
a voltage supply;
a processor;
an electrical signal switch in electrical communication with the voltage supply;
a Class F third order harmonic peaking blocking circuit segment in electrical communication with the voltage supply and with the electrical signal switch and configured to enable a drain voltage output having a time differential slope prior to signal passage through the harmonic peaking blocking circuit segment at turn-on of the switch, and wherein third order harmonics are rejected by the harmonic peaking blocking circuit;
a programmable frequency oscillator in electrical communication with the processor and that drives the switch, wherein the processor programs the frequency oscillator to establish the operating frequency of the switch; and
an inductor in electrical communication with the harmonic frequency blocking circuit segment wherein the inductor is disposed to enable electrical connection in parallel with a piezo-electric kinetic energy transducer, the transducer electrically representing a parallel resonant resistive-capacitive circuit segment that is configured to receive the oscillating signal input at the operating frequency and to produce kinetic energy output.

2. The system for at least one of calibrating and driving a piezo-electric transducer according to claim 1, further comprising:
a piezoelectric transducer electrically connected with the inductor,
wherein magnitude of the time differential slope and magnitude of the drain voltage prior to switch turn on are indicative of transducer electrical operating efficiency, and wherein
the processor measures, at at least a first operating frequency established via the programmable frequency oscillator, at least one of the drain voltage output and time slope differential prior to switch turn-on.

3. The system for at least one of calibrating and driving a piezo-electric transducer according to claim 2,
wherein the processor measures, at at least a second operating frequency established via the programmable frequency oscillator, at least one of the drain voltage output and time slope differential prior to switch turn-on,
wherein the processor compares the at least one of the drain voltage output and time slope differential prior to switch turn-on measured at the first operating frequency to the at least one of the drain voltage output and time slope differential prior to switch turn-on measured at the second operating frequency, and
wherein the processor selects one of the first operating frequency and the second operating frequency as exhibiting at least one of drain voltage output and time slope differential indicative of a higher transducer electrical operating efficiency.

4. The system for at least one of calibrating and driving a piezo-electric transducer according to claim 3, further comprising:
a memory resource enabling storage of at least one of the at least one of the drain voltage output and time slope differential prior to switch turn-on measured at the first operating frequency and the at least one of the drain voltage output and time slope differential prior to switch turn-on measured at the second operating frequency.

5. The system for at least one of calibrating and driving a piezo-electric transducer according to claim 4,
wherein the processor stores in the memory resource at least one of the at least one of the drain voltage output and time slope differential prior to switch turn-on measured at the first operating frequency and the at least one of the drain voltage output and time slope differential prior to switch turn-on measured at the second operating frequency.

6. The system for at least one of calibrating and driving a piezo-electric transducer according to claim 5,
wherein one of the at least one of the drain voltage output and time slope differential prior to switch turn-on measured at the first operating frequency and the at least one of the drain voltage output and time slope differential prior to switch turn-on measured at the second operating frequency is indicative of higher transducer electrical operating efficiency.

7. The system for at least one of calibrating and driving a piezo-electric transducer according to claim 1,
wherein the Class F third order harmonic peaking frequency blocking circuit segment precludes at least fifth order harmonics through the drain voltage.

8. The system for at least one of calibrating and driving a piezo-electric transducer according to claim 2, further comprising:
a radiometer disposed in acoustic communication with the piezoelectric transducer and in electrical communication with the processor.

9. The system for at least one of calibrating and driving a piezo-electric transducer according to claim 8,
wherein the radiometer measures acoustic power of the transducer at at least the first operating frequency.

10. The system for at least one of calibrating and driving a piezo-electric transducer according to claim 9, wherein the processor associates the acoustic power of the transducer at at least the first operating frequency with the at least one of the drain voltage output and time slope differential prior to switch turn-on at at least the first operating frequency.

11. The system for at least one of calibrating and driving a piezo-electric transducer according to claim 10, further comprising:
a memory resource enabling storage of at least one of the drain voltage output and time slope differential prior to switch turn-on measured at the first operating frequency and the acoustic power of the transducer associated with the at least first operating frequency.

12. The system for at least one of calibrating and driving a piezo-electric transducer according to claim 11,
wherein the processor stores in the memory resource at least one of the at least one of the drain voltage output and time slope differential prior to switch turn-on measured at the first operating frequency and the acoustic power of the transducer associated with the at least first operating frequency.

13. The system for at least one of calibrating and driving a piezo-electric transducer according to claim 8,
wherein the radiometer measures acoustic power of the transducer at at least the first operating frequency and the second operating frequency.

14. The system for at least one of calibrating and driving a piezo-electric transducer according to claim 13,
wherein the processor associates the acoustic power of the transducer at at least the first operating frequency with the at least one of the drain voltage output and time slope differential prior to switch turn-on at at least the first operating frequency, and
wherein the processor associates the acoustic power of the transducer at at least the second operating frequency with the at least one of the drain voltage output and time slope differential prior to switch turn-on at at least the second operating frequency.

15. The system for at least one of calibrating and driving a piezo-electric transducer according to claim 14,
wherein the processor selects one of the first operating frequency and the second operating frequency as exhibiting at least one of drain voltage output and time slope differential indicative of a higher transducer electrical operating efficiency with respect to the acoustic power measured by the radiometer at the selected frequency.

16. The system for at least one of calibrating and driving a piezo-electric transducer according to claim 15, further comprising:
a memory resource,
the memory resource enabling storage of at least one of the drain voltage output and time slope differential prior to switch turn-on measured at the selected operating frequency; the associated acoustic power of the transducer at at least the selected operating frequency; and the selected operating frequency.

17. The system for at least one of calibrating and driving a piezo-electric transducer according to claim 16,
wherein the processor stores in the memory resource at least one of the drain voltage output and time slope differential prior to switch turn-on measured at the selected operating frequency; the associated acoustic power of the transducer at at least the selected operating frequency; and the selected operating frequency.

18. The system for at least one of calibrating and driving a piezo-electric transducer according to claim 1, further comprising:
a piezoelectric transducer electrically connected with the inductor; and
a memory resource having stored therein at least one of the drain voltage output and time slope differential prior to switch turn-on measured at a selected operating frequency; an associated acoustic power of the transducer at at least the selected operating frequency; and the selected operating frequency.

19. The system for at least one of calibrating and driving a piezo-electric transducer according to claim 18, wherein the drain voltage output and time slope differential prior to switch turn-on measured at the selected operating frequency and the associated acoustic power of the transducer at at least the selected operating frequency are selected at an operating frequency of the transducer at which the transducer operates at a higher electrical efficiency with respect to the associated acoustic power as compared to operating frequencies of the transducer other than the selected operating frequency.

20. The system for at least one of calibrating and driving a piezo-electric transducer according to claim 18,
wherein the processor retrieves from the memory resource at least one of the drain voltage output and time slope differential prior to switch turn-on measured at a selected operating frequency; the associated acoustic power of the transducer at at least the selected operating frequency; and the selected operating frequency.

21. The system for at least one of calibrating and driving a piezo-electric transducer according to claim 20,
wherein the processor programs the frequency oscillator to establish the selected operating frequency as the operating frequency of the electrical signal oscillator switch therein to drive the piezoelectric transducer at the selected operating frequency retrieved from the memory resource.

22. A method for at least one of calibrating and driving a piezo-electric transducer, the method comprising the steps of:
providing:
a system for at least one of calibrating and driving a piezo-electric transducer, wherein the system comprises:
a voltage supply providing power to the system
a Class F third order harmonic peaking blocking circuit segment in electrical communication with an electrical signal switch and with the voltage supply and configured to enable a drain voltage output having a time differential slope prior to signal passage through the harmonic frequency blocking circuit at turn-on of the oscillator switch, and wherein third order harmonics are rejected by the third order harmonic peaking blocking circuit segment; and
an inductor in electrical communication with the harmonic frequency blocking circuit segment wherein the inductor is disposed to enable electrical connection in parallel with a piezo-electric transducer, the transducer electrically representing a parallel resonant resistive-capacitive circuit segment that is configured to receive the oscillating signal input at the operating frequency and to produce kinetic energy output.

23. The method for at least one of calibrating and driving a piezo-electric transducer according to claim 22, further comprising the steps of:
providing a piezoelectric transducer electrically connected with the inductor,
wherein magnitude of the time differential slope and magnitude of the drain voltage prior to switch turn on are indicative of transducer electrical operating efficiency, and
measuring, at at least a first operating frequency, at least one of the drain voltage output and time slope differential prior to switch turn-on.

24. The method for at least one of calibrating and driving a piezo-electric transducer according to claim 23, further comprising the steps of:
measuring, at at least a second operating frequency, at least one of the drain voltage output and time slope differential prior to switch turn-on,
comparing the at least one of the drain voltage output and time slope differential prior to switch turn-on measured at the first operating frequency to the at least one of the drain voltage output and time slope differential prior to switch turn-on measured at the second operating frequency, and
selecting one of the first operating frequency and the second operating frequency as exhibiting at least one of drain voltage output and time slope differential indicative of a higher transducer electrical operating efficiency.

25. The method for at least one of calibrating and driving a piezo-electric transducer according to claim 24, further comprising the step of:
providing a memory resource enabling storage of at least one of the at least one of the drain voltage output and time slope differential prior to switch turn-on measured at the first operating frequency and the at least one of the drain voltage output and time slope differential prior to switch turn-on measured at the second operating frequency.

26. The method for at least one of calibrating and driving a piezo-electric transducer according to claim 25, further comprising the step of:
storing in the memory resource at least one of the at least one of the drain voltage output and time slope differential prior to switch turn-on measured at the first operating frequency and the at least one of the drain voltage output and time slope differential prior to switch turn-on measured at the second operating frequency.

27. The method for at least one of calibrating and driving a piezo-electric transducer according to claim 26,
wherein one of the at least one of the drain voltage output and time slope differential prior to switch turn-on measured at the first operating frequency and the at least one of the drain voltage output and time slope differential prior to switch turn-on measured at the second operating frequency is indicative of higher transducer electrical operating efficiency.

28. The method for at least one of calibrating and driving a piezo-electric transducer according to claim 22,
wherein the Class F third order harmonic peaking frequency blocking circuit segment precludes at least fifth order harmonics through the drain voltage.

29. The method for at least one of calibrating and driving a piezo-electric transducer according to claim 23, further comprising the step of:
measuring the acoustic power of the transducer at at least the first operating frequency.

30. The method for at least one of calibrating and driving a piezo-electric transducer according to claim 29, further comprising the step of:
associating the acoustic power of the transducer at at least the first operating frequency with the at least one of the drain voltage output and time slope differential prior to switch turn-on at at least the first operating frequency.

31. The method for at least one of calibrating and driving a piezo-electric transducer according to claim 30, further comprising the step of:
providing a memory resource enabling storage of at least one of the drain voltage output and time slope differential prior to switch turn-on measured at the first operating frequency and the acoustic power of the transducer associated with the at least first operating frequency.

32. The method for at least one of calibrating and driving a piezo-electric transducer according to claim 31, further comprising the step of:
storing in the memory resource at least one of the at least one of the drain voltage output and time slope differential prior to switch turn-on measured at the first operating frequency and the acoustic power of the transducer associated with the at least first operating frequency.

33. The method for at least one of calibrating and driving a piezo-electric transducer according to claim 24, further comprising the step of:
measuring acoustic power of the transducer at at least the first operating frequency and the second operating frequency.

34. The method for at least one of calibrating and driving a piezo-electric transducer according to claim 33, further comprising the steps of:
associating the acoustic power of the transducer at at least the first operating frequency with the at least one of the drain voltage output and time slope differential prior to switch turn-on at at least the first operating frequency, and
associating the acoustic power of the transducer at at least the second operating frequency with the at least one of the drain voltage output and time slope differential prior to switch turn-on at at least the second operating frequency.

35. The method for at least one of calibrating and driving a piezo-electric transducer according to claim 34, further comprising the step of:
selecting one of the first operating frequency and the second operating frequency as exhibiting at least one of drain voltage output and time slope differential indicative of a higher transducer electrical operating efficiency with respect to the acoustic power measured at the selected frequency.

36. The method for at least one of calibrating and driving a piezo-electric transducer according to claim 35, further comprising the step of:
providing a memory resource,
the memory resource enabling storage of at least one of the drain voltage output and time slope differential prior to switch turn-on measured at the selected operating frequency; the associated acoustic power of the transducer at at least the selected operating frequency; and the selected operating frequency.

37. The method for at least one of calibrating and driving a piezo-electric transducer according to claim 36, further comprising the step of:
storing in the memory resource at least one of the drain voltage output and time slope differential prior to switch turn-on measured at the selected operating frequency; the associated acoustic power of the transducer at at least the selected operating frequency; and the selected operating frequency.

38. The method for at least one of calibrating and driving a piezo-electric transducer according to claim 22, further comprising the steps of:
providing a piezoelectric transducer electrically connected with the inductor; and
providing a memory resource having stored therein at least one of the drain voltage output and time slope differential prior to switch turn-on measured at a selected operating frequency; an associated acoustic power of the transducer at at least the selected operating frequency; and the selected operating frequency.

39. The method for at least one of calibrating and driving a piezo-electric transducer according to claim 38, further comprising the step of:
selecting the drain voltage output and time slope differential prior to switch turn-on and the associated acoustic power of the transducer at at least an operating frequency of the transducer at which the transducer operates at a higher electrical efficiency with respect to the associated acoustic power as compared to operating frequencies of the transducer at other than the selected operating frequency.

40. The method for at least one of calibrating and driving a piezo-electric transducer according to claim 38, further comprising the step of:
retrieving from the memory resource at least one of the drain voltage output and time slope differential prior to switch turn-on measured at a selected operating frequency; the associated acoustic power of the transducer at at least the selected operating frequency; and the selected operating frequency.

41. The method for at least one of calibrating and driving a piezo-electric transducer according to claim 40, further comprising the step of:
programming the frequency oscillator to establish the selected operating frequency as the operating frequency of the electrical signal oscillator switch; and
driving the piezoelectric transducer at the selected operating frequency retrieved from the memory resource.
